(19) United States
(12) Patent Application Publication
(10) Pub. No.: US 2025/0293257 A1
(43) Pub. Date: Sep. 18, 2025

(54) LITHIUM-ION BATTERY COMPONENT WITH POLAR BINDER

(71) Applicant: FORD GLOBAL TECHNOLOGIES, LLC, Dearborn, MI (US)

(72) Inventors: Insik JEON, Novi, MI (US); Jonghwan PARK, Ann Arbor, MI (US); DongHyun LEE, Northville, MI (US); Wei XU, Livonia, MI (US)

(73) Assignee: FORD GLOBAL TECHNOLOGIES, LLC, Dearborn, MI (US)

(21) Appl. No.: 18/608,825

(22) Filed: Mar. 18, 2024

(51) Int. Cl. H01M 4/62; H01M 4/04; H01M 4/38; H01M 4/583; H01M 10/0525

(52) U.S. Cl. CPC H01M 4/622; H01M 4/0435; H01M 4/382; H01M 4/583; H01M 4/625; H01M 10/0525

(57) ABSTRACT

A lithium-ion battery component is presented. The lithium-ion battery component has an electrode with a current collector and an electrode sheet laminated thereon including conducting agents and a polar cross-linkable B-A-B binder mechanically binding the conducting agents in a sterically stabilized dispersion configured to permit volume expansion of the electrode sheet during charge of the electrode and facilitate volume contraction of the electrode sheet during discharge of the electrode.

### TECHNICAL FIELD

The disclosure relates to electrode materials for lithium-ion batteries.

### BACKGROUND

In the development of lithium-ion battery (LIB) electrodes, traditional manufacturing techniques often rely on the use of solvents to mix and adhere the active materials and conductors to form the electrode film. These methods pose certain challenges. Additionally, the drying process required to remove solvents can be energy-intensive and may affect the integrity of the electrode structure.

Polytetrafluoroethylene (PTFE), a widely used binder in the fabrication of LIB electrodes due to its chemical stability and mechanical strength, has challenges. Despite its beneficial properties, PTFE's inherent non-polar nature may lead to poor adhesion and cohesion with the polar surfaces of conductors and active materials. This may result in suboptimal dispersion of these components. To address these challenges, there is a growing interest in developing solvent-free methods for producing LIB electrodes.

### SUMMARY

In one aspect of the disclosure a lithium-ion battery component is presented. The lithium-ion battery component includes an electrode having a current collector and an electrode sheet laminated thereon including conducting agents and a polar cross-linkable B-A-B binder mechanically binding the conducting agents in a sterically stabilized dispersion configured to permit volume expansion of the electrode sheet during charge of the electrode and facilitate volume contraction of the electrode sheet during discharge of the electrode. The B group in the polar cross-linkable B-A-B binder may be acrylate or epoxy. The A group in the polar cross-linkable B-A-B binder may be urethane, epoxy, or glycol. The conducting agents may include carbon black and carbon nanotubes. The electrode sheet includes active materials. The active materials may include lithium. In other configurations, the active materials may include graphite. The polar cross-linkable B-A-B binder may have a viscosity of at least 500 centipoise at 25 degrees Celsius. The polar cross-linkable B-A-B binder may have a molecular weight of at least 200 grams per mol.

In another aspect of the disclosure a method is presented. The method begins with mixing a gel-oligomer with conducting agents such that a sterically dispersed mixture forms. Then adding electrode active materials to the sterically dispersed mixture to form a self-supporting electrode film, and roll-pressing the self-supporting electrode film with a current collector to form a laminated electrode. The gel-oligomer may be a polar cross-linkable B-A-B binder. The B group of the polar cross-linkable B-A-B binder may be selected from one of acrylate or epoxy. The A group in the polar cross-linkable B-A-B binder may selected from one of urethane, epoxy, or glycol.

In yet another aspect of the disclosure, a lithium-ion battery is presented. The lithium-ion battery has a separator; and a pair of electrodes sandwiching the separator, at least one of the electrodes including an electrode sheet, laminated with a current collector, having conducting agents sterically stabilized by a polar cross-linkable B-A-B binder mechanically binding the dispersed conducting agents. The B group in the polar cross-linkable B-A-B binder may be selected from one of acrylate or epoxy. The A group in the polar cross-linkable B-A-B binder may be selected from one of urethane, epoxy, or glycol. The conducting agents may include carbon black and carbon nanotubes. The electrode sheet may include active materials. The polar cross-linkable B-A-B binder may have a viscosity of at least 500 centipoise at 25 degrees Celsius. In some configurations, the polar cross-linkable B-A-B binder has a molecular weight of at least 200 grams per mol.

### BRIEF DESCRIPTION OF THE DRAWINGS

FIG. 1 is a schematic diagram of a B-A-B binder and its substitute groups according to any one or more aspects of the disclosure;

FIG. 2 is a schematic diagram of a lithium-ion according to any one or more aspects of the disclosure;

FIG. 3 is a schematic diagram of a manufacturing process according to any one or more aspects of the disclosure; and

FIG. 4 is a flowchart of a manufacturing process according to any one or more aspects of the disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The disclosure relates to the fabrication of lithium-ion battery (LIB) components, and increasing the adhesion in an electrode structure through its assembly. Gel-type cross-linkable oligomers are introduced as binders. These oligomers are polar binders and take the form of a cross-linkable B-A-B type monomer and/or oligomer. The specific physical properties of the B-A-B type binder are a viscosity of at least 500 centipoise at 25 degrees Celsius and a molecular weight of at least 200 grams per mole. These properties enable the binder to act as a liquid gel, facilitating the solvent-free dispersion of conductors and electrode materials.

The binder's design includes two distinct types of functional groups. The ‘A’ component is substituted with polar groups such as urethane, epoxy, and glycol, which facilitate particle dispersion and adhesion to the current collectors. The ‘B’ component comprises groups such as acrylate and epoxy that are central for the formation of a strong film upon the binder's curing. The use of B-A-B binders is adaptable, allowing for their application either independently or in combination with other binders, including PTFE.

A lithium-ion battery component according to one or more aspects of the disclosure, has an electrode with a current collector and an electrode sheet laminated on top. The sheet may include conducting agents mixed with the polar cross-linkable B-A-B binder, achieving a dispersion that supports the electrode sheet's volume changes during the battery's charge and discharge cycles. The conducting agents, such as carbon black and carbon nanotubes, are selected for their contribution to the electrode's electrical conductivity. The active materials, for the battery's energy storage and release capabilities, may be lithium and graphite among others.

A manufacturing process according to one or more aspects of the disclosure, involves mixing a gel-oligomer binder with conducting agents to create a uniformly dispersed mixture. Following the addition of active materials, this leads to the formation of a self-supporting electrode film. The subsequent step of roll-pressing this film with a current collector culminates in a laminated electrode with the conducting agents being mechanically bound in a configuration conducive to volume adjustments. In an assembled battery according to one or more embodiments, a separator and a pair of electrodes are provided, with at least one electrode integrating the disclosed electrode sheet and current collector setup. This arrangement is aimed at maintaining the dimensional stability and mechanical integrity of the electrode. Through the outlined approach, gel-type cross-linkable oligomers may be incorporated in lithium-ion batteries.

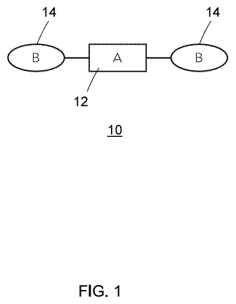

Referring now to FIG. 1, a schematic diagram of a B-A-B type binder 10 is shown. The B-A-B type binder 10 may be a gel-type cross-linkable oligomer incorporated in lithium-ion batteries. The binder 10 has one A functional group 12 and two B functional groups 14. Although, one A functional group and two B functional groups are shown, the B-A-B type binder 10 may have one or more of each respective functional group. The A group 12 may be substituted with urethane, epoxy, glycol, or any other suitable group. The A group 12 substitutes are selected from polar functional groups which promote particle dispersion and surface adhesion onto current collectors. The B group 14 may be substituted with acrylate, epoxy, or any other suitable group. The B group 14 substitutes are selected from cross-linkable moieties for mechanical robustness of the binder. One example of a suitable B-A-B type binder is diurethane dimethacrylate. The B-A-B type binder 10 is a gel-type cross-linkable oligomer that has an initial solvent-like property for steric dispersion, and after curing provides a durable electrode film property through its strong cross-linking between molecules. Steric stabilization refers to a method used to prevent particles within a dispersion from clumping together. In the context of lithium-ion battery manufacturing, steric stabilization is achieved by using large molecules, such as gel-type cross-linkable oligomers 10, to coat a surface of conducting agents like carbon black and carbon nanotubes. This coating helps maintain a uniform dispersion of these agents within the binder matrix, for consistent electrical conductivity throughout the electrode. Additionally, it accommodates volume changes during the battery's charge and discharge cycles.

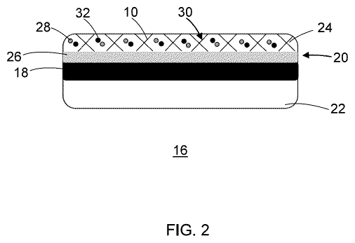

In FIG. 2, a lithium-ion battery component 16 is shown. The lithium-ion battery component 16 shown is a lithium-ion battery cell. The lithium-ion battery cell 16 has a separator 18 sandwiching a pair of electrodes 20 and 22. The electrode 20 has an electrode sheet 24 laminated with a current collector 26 having conducting agents 28 sterically stabilized by the polar cross-linkable B-A-B binder 10 mechanically binding the dispersed conducting agents 28 in a sterically stabilized dispersion 30. The sterically stabilized dispersion 30 is configured to permit volume expansion of the electrode sheet 24 during charge of the electrode 20 and facilitate volume contraction of the electrode sheet 24 during discharge of the electrode 20. While the electrode 20 is shown with the electrode sheet 24, the electrode sheet 24 may be incorporated into either or both electrodes. The conducting agents 28 may be carbon black, carbon nanotubes, or any other material with suitable electrochemical properties. The electrode sheet 24 includes active materials 32. The active materials 32 may be either anode or cathode materials such as lithium or graphite depending on the application.

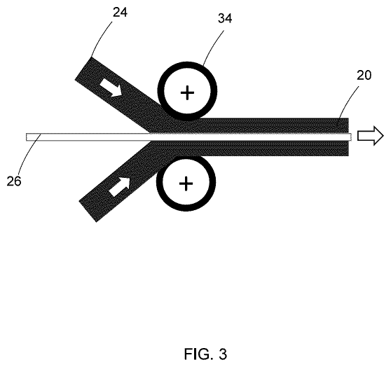

To form the electrode sheet 24, the polar cross-linkable B-A-B binder 10 is mixed with the conducting agents 28 until the conductors 28 are sterically stabilized. Then the suitable active materials 32 are added to the binder 10 with sterically stabilized conducting agents 28 to form an electrode sheet 24. The active materials 32 may optionally be mixed with a fibrillation-based binder such as polytetrafluoroethylene. In FIG. 3, the electrode sheet 24 is fed through rollers 34 and laminated with current collector 26. The laminated electrode 20 may be further cured to promote cross-linking through thermal curing, catalytic processes, UV curing, E-beam laser application, or any other suitable method.

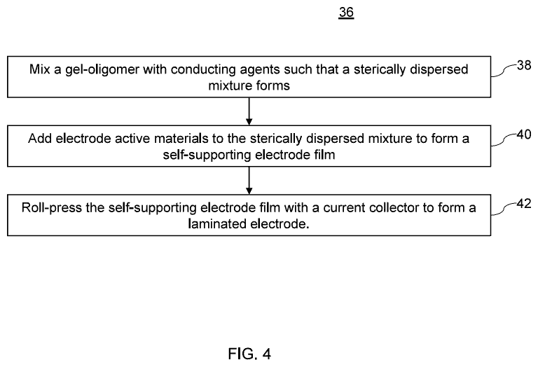

FIG. 4 is a flowchart of a manufacturing method according to one or more embodiments of the disclosure. In block 38, the method 36 begins with mixing a gel-oligomer with conducting agents such that a sterically dispersed mixture forms. The gel-oligomer may be a B-A-B type binder with one or more A functional groups and one or more B functional groups. The A group substitutes are selected from polar functional groups which promote particle dispersion and surface adhesion onto current collectors. The A group substitutes may be urethane, epoxy, glycol, or any other suitable group. The B group substitutes are selected from cross-linkable moieties for mechanical robustness of the binder. The B group substitutes may be acrylate, epoxy, or any other suitable group. The conducting agents may be carbon black or carbon nanotubes. Then in block 40, electrode active materials are added to the sterically dispersed mixture to form a self- supporting electrode film. The active materials may be either anode or cathode materials such as lithium or graphite depending on the application.

In block 42, the self-supporting electrode film is roll-pressed with a current collector to form a laminated electrode. In some configurations, the laminated electrode may be further cured to promote cross-linking through thermal curing, catalytic processes, UV curing, E-beam laser application, or any other suitable method. Thermal curing involves heating the material, which initiates a chemical reaction leading to the cross-linking of polymer chains within the binder. Catalytic curing hastens the chemical reactions at lower temperatures or shorter times compared to thermal curing. Utilizing ultraviolet light, UV curing initiates the curing process without the need for heat, leading to rapid cross-linking of the binder.

E-beam curing employs high-energy electrons to induce cross-linking, offering very fast curing times and the ability to penetrate deeply into the material. It is an environmentally friendly option that can cure materials without solvents, producing robust, chemically resistant films. This method is particularly effective when uniform curing throughout the thickness of the material is required.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, case of assembly, etc. As such, embodiments described as less desirable than other embodiments or prior art implementations with respect to one or more characteristics are not outside the scope of the disclosure and may be desirable for particular applications.

What is claimed is:

1. A lithium-ion battery component comprising:
an electrode having a current collector and an electrode sheet laminated thereon including conducting agents and a polar cross-linkable B-A-B binder mechanically binding the conducting agents in a sterically stabilized dispersion configured to permit volume expansion of the electrode sheet during charge of the electrode and facilitate volume contraction of the electrode sheet during discharge of the electrode.

2. The lithium-ion battery component of claim 1 wherein a B group in the polar cross-linkable B-A-B binder is selected from one of acrylate and epoxy.

3. The lithium-ion battery component of claim 1 wherein an A group in the polar cross-linkable B-A-B binder is selected from one of urethane, epoxy, and glycol.

4. The lithium-ion battery component of claim 1 wherein the conducting agents include carbon black and carbon nanotubes.

5. The lithium-ion battery component of claim 1 wherein the electrode sheet includes active materials.

6. The lithium-ion battery component of claim 5 wherein the active materials include lithium.

7. The lithium-ion battery component of claim 5 wherein the active materials include graphite.

8. The lithium-ion battery of claim 1 wherein the polar cross-linkable B-A-B binder has a viscosity of at least 500 centipoise at 25 degrees Celsius.

9. The lithium-ion battery of claim 1 wherein the polar cross-linkable B-A-B binder has a molecular weight of at least 200 grams per mol.

10. A method comprising:
mixing a gel-oligomer with conducting agents such that a sterically dispersed mixture forms;
adding electrode active materials to the sterically dispersed mixture to form a self-supporting electrode film; and
roll-pressing the self-supporting electrode film with a current collector to form a laminated electrode.

11. The method of claim 10 wherein the gel-oligomer is a polar cross-linkable B-A-B binder.

12. The method of claim 11 wherein a B group of the polar cross-linkable B-A-B binder is selected from one of acrylate and epoxy.

13. The method of claim 11 wherein an A group in the polar cross-linkable B-A-B binder is selected from one of urethane, epoxy, and glycol.

14. A lithium-ion battery comprising:
a separator; and
a pair of electrodes sandwiching the separator, at least one of the electrodes including an electrode sheet, laminated with a current collector, having dispersed conducting agents sterically stabilized by a polar cross-linkable B-A-B binder mechanically binding the dispersed conducting agents.

15. The lithium-ion battery of claim 14 wherein a B group in the polar cross-linkable B-A-B binder is selected from one of acrylate and epoxy.

16. The lithium-ion battery of claim 14 wherein an A group in the polar cross-linkable B-A-B binder is selected from one of urethane, epoxy, and glycol.

17. The lithium-ion battery of claim 14 wherein the conducting agents include carbon black and carbon nanotubes.

18. The lithium-ion battery of claim 14 wherein the electrode sheet includes active materials.

19. The lithium-ion battery of claim 14 wherein the polar cross-linkable B-A-B binder has a viscosity of at least 500 centipoise at 25 degrees Celsius.

20. The lithium-ion battery of claim 14 wherein the polar cross-linkable B-A-B binder has a molecular weight of at least 200 grams per mol.
